(19) United States
(12) Patent Application Publication
(10) Pub. No.: US 2007/0165799 A1
(43) Pub. Date: Jul. 19, 2007

(54) IVR AUTHENTICATION AND INTENTION VERIFICATION SYSTEM

(75) Inventor: Robert M. Juncker, Farmington, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Gearworks, Inc., Eagan, MN (US)

(21) Appl. No.: 11/622,410

(22) Filed: Jan. 11, 2007

Related U.S. Application Data
(60) Provisional application No. 60/758,596, filed on Jan. 11, 2006.

(51) Int. Cl. H04M 1/64

(52) U.S. Cl. 379/88.21

(57) ABSTRACT

A system for providing interactive voice response (IVR) service includes an intelligent IVR system and a database having a plurality of datasets for use in automatically authenticating a user and automatically determining the user's intention. Some embodiments of the intelligent IVR system use GPS data to automatically determine the user's intention. Some embodiments of communication devices include an IVR data application operable to communicate with the intelligent IVR system and thereby automatically authenticate the user and determine user intention.

### CROSS-REFERENCE TO RELATED APPLICATIONS

This application claims the benefit of Provisional Application No. 60/758,596, filed on Jan. 11, 2006, which is hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright ® 2006-2007 Gearworks, Inc.

### TECHNICAL FIELD

Various embodiments of the present invention generally relate to interactive communication systems. More specifically, the embodiments of the present invention relate to interactive voice response systems providing user authentication and intention verification.

### BACKGROUND

Interactive voice response (IVR) is a telephony technology in which a caller uses a touch-tone telephone to interact with a database to acquire information from or enter data into the database. IVR technology does not require human interaction over the telephone as the user's interaction with the database is predetermined by what the IVR system will allow the user access to. For example, banks and credit card companies use IVR systems so that their customers can receive up-to-date account information instantly and easily without having to speak directly to a person. IVR technology is also used to gather information, as in the case of telephone surveys in which the user is prompted to answer questions by pushing the numbers on a touch-tone telephone.

When a caller dials into an IVR system, there are typically two parts of the IVR interaction: identification and intention. Identification occurs first and is focused on authenticating the user's identity. For example, the IVR system may prompt the caller to enter an identification number or other information that validates or authenticates the caller to use the IVR system. After the user is authenticated, he/she selects from a series of options to indicate the user's “intention”. The user's intention refers to the purpose of the call, or what it is the user wants to accomplish with the call. Using an airline IVR system as an example, the user may be prompted first to enter a “frequent flier number” (identification) into the IVR system. Next, the user may be prompted to specify an IVR service that the user wants to access (intention). For example, the user may be prompted as follows: “Press 1 to redeem your miles for a trip. Press 2 to speak with a customer service agent.”

Unfortunately, in traditional systems, the identification portion of an IVR interaction can be time consuming, laborious, and error prone. For example, in some cases, the user may be required to enter a long password or identifier (e.g., 8 or more characters). As we all know, passwords and identifiers are easily forgotten, or documents that include this data are misplaced. Thus, a user may need to spend time searching for, or trying to remember, a password or identifier. In addition, in some cases users must access an IVR system multiple times, which consumes additional time for entering ID/password data. For example, if the user forgets to access an IVR service during a first IVR interaction before hanging up, the user will be required to enter the identifier and/or password again in another IVR interaction.

A particular application of IVR is in the area of field workforce industries. Such industries employ workers who travel to various locations to perform their services. By way of example, delivery companies, home/product repair companies, sales companies, and home health care services employ field workforces. In addition, companies such as telecommunications companies, network service providers, and power companies, which deploy and maintain field equipment (e.g., telecommunications/power lines), typically employ field workforces. In these industries, field workers often use IVR systems to retrieve or enter information from the field. In some cases a field worker may need to dial into the IVR system repeatedly throughout the day, or during the course of a job. In such cases, the authentication process can present a significant burden on the field worker. In addition, the process of determining the worker's intention every time the worker calls can be burdensome, time consuming, and costly in terms of worker time.

### SUMMARY

Systems and methods are described for interactive voice response. More specifically, the embodiments of the present invention relate to interactive voice response authentication and intention verification systems. In some embodiments, a server side interactive voice response (IVR) system may include an interface module and an intelligent interactive voice response server. The interface module may be configured to receive one or more user attributes from a communication device via a communications channel. The intelligent IVR server may be configured to automatically determine a context and/or intention of a user based on the one or more user attributes. Examples of user attributes include, but are not limited to, a user identification (e.g., a user name, a password, a code, a frequent flier number, a bank account number, or an insurance policy/group number), a job identification, task data, location data, IVR prompts, and an intention.

In some embodiments, the IVR system response may be based on the determined intention of the user. Once the system response is determined, the IVR system response may be transmitted to the communication device. In one embodiment, the one or more user attributes include location data from one a mobile communication device associated with a mobile user. The location data may then used by the intelligent IVR server to determine a current activity of the mobile user.

Various embodiments of the IVR system may also include a memory storing user context determination data. Examples of context determination data includes, but is not limited to, job identification data, user identification data, location data, or global positioning system data. In some embodiments, the IVR system may include an application module to host one or more applications which may be accessed by the communication device.

The IVR system, according to various embodiments, may also include a set of standard response options. One or more of these standard options may be based on the determined intention of the user before the IVR system response is transmitted to the communication device.

Some embodiments include a method that includes receiving a first communication signal from a communication device, authenticating the user of the communication device, determining a user intent, and transmitting a second communication signal to the communication device. According to one embodiment, the first communication signal may include one or more user attributes associated with a user of the communication device. In some embodiments, the authenticating the user of the communication device may be accomplished by matching one or more of the user attributes received in the communication signal with context determination data located on a server. According to various embodiments, the determination of the user intent may be based on the one or more user attributes.

In accordance with one or more embodiments, the second communication signal may include a menu of one or more options based on the determined user intent. The menu of one or more options included in the second communication signal may a standard or default option menu if determining the user intent fails. In some embodiments, the menu of one or more options includes an IVR prompt, sequence of prompts or information for the user.

In some embodiments, the communication device may be able to determine a current user position based on location data, such as global positioning system (GPS) data. A current position based on the GPS data may be determined along with one or more activities associated with the current position. A job identification indicator included in the one or more user attributes may be used to index into the one or more activities.

One or more embodiments of the present invention may include a communication device. The communication device of various embodiments may include a memory store, an input/output (I/O) module, a data application module, and/or a user attribute module. In one embodiment, the memory store may have one or more executable applications to interact with an intelligent interactive voice recognition (IVR) system. The input/output (I/O) module may provide one or more modes of communication service (e.g., push-to-talk or full-duplex communication) between the communication device and an IVR server. The data application module may be configured to send and receive data to and from an IVR server application via the I/O module. The user attribute module may be configured to receive and record one or more user attributes associated with a user of the communication device. The user attribute module, according to various embodiments, automatically transmits one or more quality indicators to the IVR server on a prescheduled, periodic, or event driven schedule.

In various embodiment, the communication device may include a global positioning system that is able determine a current location of the communication device and provide the current location to the data application module. In some embodiments, the communication device may also include a user interface allowing the user to set one or more user attributes.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

FIG. 1 illustrates an exemplary operating environment including exemplary mobile devices communicating via a network(s) with a server hosting an intelligent IVR system.

FIG. 2 is a diagrammatic representation of a system in which a communication device interacts with an intelligent IVR system in accordance with one embodiment of the present invention.

FIGS. 3-4 are flowcharts illustrating algorithms for use in performing IVR authentication and intention verification in accordance with an embodiment of the present invention.

FIG. 5 is a schematic diagram of a computing device upon which embodiments of the present invention may be implemented and carried out.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Definitions

Prior to describing one or more preferred embodiments of the present invention, definitions of some terms used throughout the description are presented.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The term “carrier” refers broadly to any type of telecommunications carrier. A carrier typically maintains a network, such as a wireless or cellular network, over which mobile service providers, and others can communicate and/or access an IVR system. Carriers can also provide services (e.g., applications) on their network. By way of example, but not limitation, Nextel®, Verizon®, and Sprint® are telecom carriers.

The term “customer” includes mobile service provider companies who dispatch mobile service providers to field locations to provide services. Such mobile service providers typically have a wireless mobile communication device, through which they may communicate with applications associated with an interactive voice response (IVR) system. By way of example, but not limitation, lawn maintenance companies, food and drink distributors, product delivery companies, and companies that use field technicians, may be customers by virtue of services that they provide “in the field”.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “responsive” includes completely or partially responsive.

The term “computer-readable media” is media that is accessible by a computer, and can include, without limitation, computer storage media and communications media. Computer storage media generally refers to any type of computer-readable memory, such as, but not limited to, volatile, non-volatile, removable, or non-removable memory. Communication media refers to a modulated signal carrying computer-readable data, such as, without limitation, program modules, instructions, or data structures.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

For the sake of illustration, various embodiments of the present invention have herein been described in the context of computer programs, physical components, and logical interactions within modern computer and communication networks. Importantly, while these embodiments describe various aspects of the invention in relation to modern computer and communication networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices and systems. More specifically, embodiments are applicable to communication systems, services, and devices such as cell phone networks and compatible devices.

Exemplary System

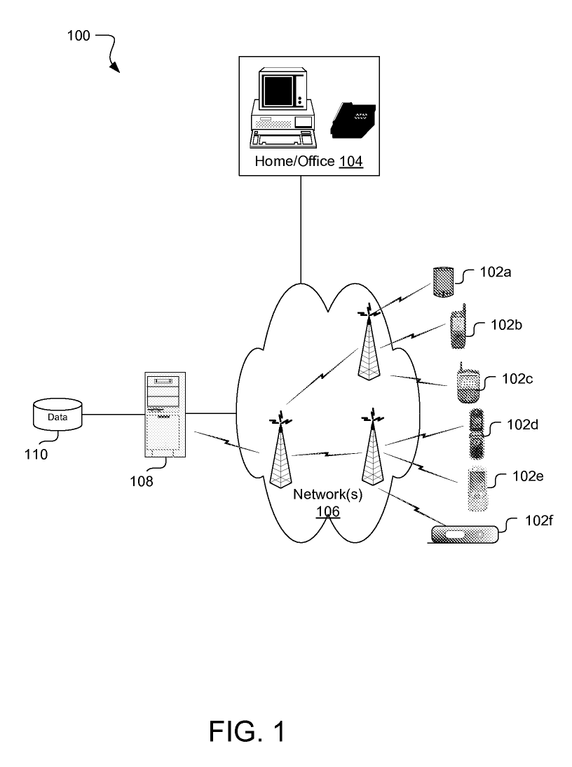

FIG. 1 illustrates an exemplary IVR operating environment 100 including one or more exemplary mobile communication devices 102 and one or more homes or offices 104 operable to communicate via a network 106. The mobile devices 102 and the home/office 104 are in communication with an intelligent IVR server 108 via the network 106. The intelligent IVR server 108 generally provides IVR services to mobile devices 102 and/or computing/communication devices at the home/office 104. More specifically, the intelligent IVR server 108 implements an intelligent IVR system, embodiments of which are discussed in more detail below. As discussed in further detail below, embodiments of the intelligent IVR system can provide IVR services in a manner that is based on a context associated with a user, a communication device 102 and/or home/office 104.

Users of communications devices 102 and home/office 104 computers can be any type of users in any setting. As such, users may be generally categorized as either mobile or static. Although the users can be of any type, for illustrative purposes, in the described embodiments mobile communication devices 102 are assumed to be used by a mobile workforce. Mobile communication devices 102 are typically relatively small so that they are easily carried by mobile workers, such as plumbers, electricians, field technicians, delivery personnel, home medical providers, and others. Mobile communication devices 102 are typically GPS-enabled, provide wireless communication, and include input/output means, such as audio, a screen, touch screen input, keypad, and others. As such, a mobile communication device 102 is typically operable to input and output a variety of data, such as, but not limited to, voice, graphics, numerical, dual-tone multi-frequency (DTMF), and application-specific data.

In addition, one or more of the mobile communication devices 102 may provide push-to-talk (PTT) functionality. PTT is a two-way communication service that works like a “walkie-talkie”. PTT is half-duplex, meaning communication can only travel in one direction at any given moment. Some mobile communication devices 102, such as NEXTEL® handsets using DirectConnect®, provide PTT in addition to standard full-duplex communication. As is discussed in more detail below, PTT and other standard modes of communication (e.g., touchtone) can be used to engage an intelligent IVR system discussed in detail below.

Accordingly, by way of example, but not limitation, mobile communication devices 102 include personal digital assistants (PDA) 102a, JAVA-based phones 102b, cellular telephones, such as “black-phones” 102c (e.g., Blackberry®), BREW-based phones 102d, and Windows-based phones 102e, as well as vehicle-mounted “black boxes” 102f. A black box 102f is a device that is installed in a vehicle and typically does not include a user interface. The black box 102f has embedded intelligence that allows the black box 102f to capture vehicle diagnostic information and GPS positioning information.

Mobile communication devices 102 and home/office 104 communication devices are operable to interact with the an intelligent IVR system executing at the IVR server 108. In a particular embodiment, a mobile communication device 102 has an executable application that performs IVR interaction operations that can make IVR interaction fast and efficient for a mobile user. The operations or services performed by the IVR server 108 may be based on, or in response to, user attributes that are provided to the server 108 by a user's communication device 102. One or more user attributes may or may not be sent automatically by the communication device 102. For example, a data application running on a mobile communication device 102 may automatically transmit user identification (ID) data to the server 108. In this example, when the user accesses the IVR server 108, the user identification process is transparent to the user, and the user will not be required to manually enter user identification information.

As another example, the data application may automatically and periodically communicate location data, such as GPS data or street address data, to the server 108, so that the server-based intelligent IVR system is aware of the mobile user's location substantially continuously and/or prior to the user calling the IVR system. As is discussed in further detail below, the IVR system can use the user attributes, such as location and the user identification data, to determine the context of the user. The user's context refers generally to the user's situation, and can include characteristics such as user ID, user title, user company, location, time, job, activities that make up the job, activity being performed within the job, user compensation, company-specific requirements, marketing (e.g., upselling), and others. Thus, data exchange between communication devices 102 and the IVR server 108 can facilitate context-specific IVR interactions.

The intention of the user in calling the IVR system is typically related to the user's context. In some embodiments, the IVR system uses the user context to attempt to automatically determine an intention of the user in calling into the system. By determining user context and/or intention automatically prior to, or during, an interaction with the user, the IVR server 108 can streamline IVR interactions by removing steps or user input that would have otherwise been required. For example, the IVR server can “pre-authenticate” the user, so that the user does not need to enter (e.g., type in or say) the user's ID. As another example, the IVR server 108 can provide job-specific or task-specific menus to the user, without the user being required to manually notify the IVR server 108 of the user's job or task.

In the illustrated embodiment, the intelligent IVR server 108 is in communication with one or more databases 110. Database 110 stores IVR-related, context determination data, intention determination data, and/or other data. For example, the database 110 may include user identification data, telephone numbers, passwords, GPS locations, intention data, prompts, job data and task data. The database 110 may be a relational database. In other embodiments, database 110 may contain flat files. An IVR system executing on the server 108 may be “data driven”, wherein the format or content of the data in the database 110 dictates the order of IVR processing. The IVR server 108 includes functionality to connect to, and communicate with, mobile communication devices 102 via the network 106.

The mobile communication devices 102 each provide for telephonic connection and communication via the network 106. For example, a mobile communication device 102 can dial a telephone number to thereby connect to an IVR system on the server 108. In addition, the intelligent IVR system can use, or be accessed by, push-to-talk (PTT) technology. The network 106 typically includes multiple interconnected subnetworks. The subnetworks may be deployed and maintained by telecommunication carriers, backbone network providers, voice over IP (VOIP) network service providers, and others, and may carry data/signals in numerous different formats. As such, communications between a mobile communication device 102 and the server 108 may traverse multiple subnetworks. For example, communications may go through circuit-switched (e.g., public switched telephone network (PSTN)) and/or packet-switched (e.g., VOIP) subnetworks, and communications data/signaling may be formatted and/or reformatted when going from one subnetwork to the next. With regard to PTT, PTT systems are available that use VOIP technology to provide PTT service digitally over third generation (3G) data networks. As such, the network 106 provides a communication channel between server 108 and communication devices 102 and home/office 104 communication devices.

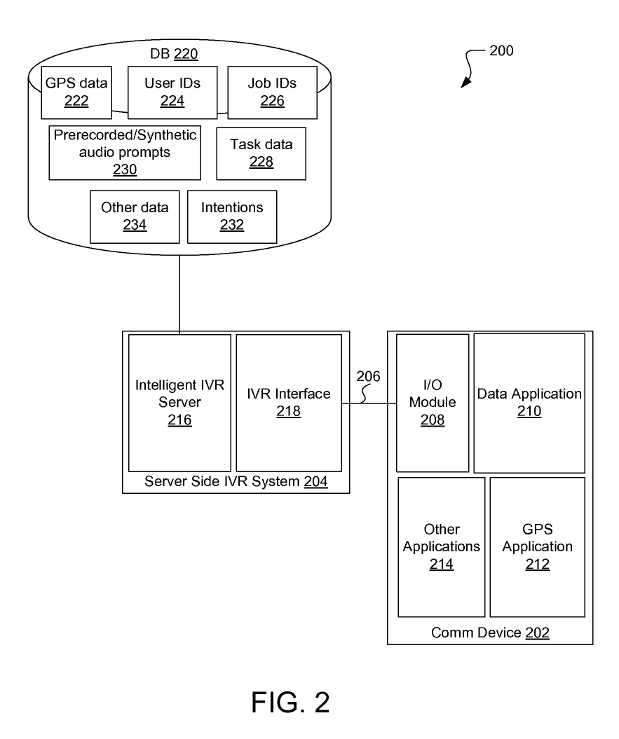

FIG. 2 is a diagrammatic representation of a system 200 including a communication device 202 in communication with an intelligent server side IVR system 204 via a communication channel 206 in accordance with one particular embodiment. In the embodiment illustrated, communication device 202 includes a number of modules: input/output (I/O) module 208, IVR data application 210, GPS application 212, and optionally other applications 214. The IVR system 204 includes an intelligent IVR server application 216 and an IVR interface 218. Through the IVR interface 218, the communication device 202 communicates with the intelligent IVR server application 216. The IVR interface 218 and I/O module 208 can provide one or more modes of communication service, such as, but not limited to PTT and/or standard full-duplex communication (e.g., via touchtone telephone). Of course, IVR interface 218 and I/O module 208 can provide communication via wireless or wireline channel (or any combination of wireless or wireline)

More specifically, IVR data application 210 sends data to, and receives data from, the IVR server application 216 via the I/O module 208, communication channel 206, and IVR interface 218. The intelligent IVR server application 216 uses data received from the IVR data application 210 to perform various IVR functions, such as, but not limited to, user authentication and intention verification. The intelligent IVR server application 216 may also provide audio prompts to the IVR interface 218, which can present the prompts to the communication device 202. In some embodiments, the IVR interface 218 can generate prerecorded and/or synthetic voice dialog. The IVR data application 210 at the communication device 202 may send data automatically and/or send data in response to user commands/input.

In some embodiments, in advance of an IVR interaction, at least some user attributes may be transmitted to the IVR system 204. In various embodiments, the transmission of the user attributes may be done on a scheduled basis, a periodic basis, or on an event-driven basis. For example, a user may manually enter a job ID triggering transmission of this user attribute to the IVR system 204. In some cases, the IVR system 204 may poll communication devices requesting user attributes. Later, when a user calls the IVR system 204, the user context and intention may have already been determined by the IVR system 204.

In the embodiment shown, the intelligent IVR server 216 uses data from the communication device 202 and data in a database 220 to determine IVR responses in a user context-sensitive manner. The database 220 includes GPS data 222, user ID data 224, job ID data 226, task data 228, IVR prompts 230 (prerecorded and/or synthetic), intentions 232, and other data 234. In one embodiment the various datasets are stored in the database 220 in a relational manner. For example, each of the job IDs 226 may be associated with one or more tasks from the task data 228. As another example, user IDs 224 may each be related to one or more jobs in the job ID data 226. As yet another example, GPS locations in GPS data 222 may each be associated with one or more job IDs 226 and/or tasks 228. GPS data 222, user ID data 224, and job ID data 226 are examples of user context determination data (i.e., the data that is used to determine user context). Data entries in any or all of the datasets may be associated with one or more intentions 234. Using the database 220, the intelligent IVR server 216 can determine or verify user intention and/or authenticate the user based on a context associated with the communication device 202 or user.

Embodiments of the present invention may be used in mobile workforce environments that utilize a plurality of mobile workers making appointments. For example, the mobile workers may be appliance repair specialists, carpet cleaners, painters, as well as others. The IVR system may have a list of jobs or activities associated with a user of the IVR system. For example, when a mobile worker who has been assigned an appointment at 1:00 p.m. calls at a time close to 1:00 p.m., the mobile communication device may transmit GPS location data. The IVR system 204 may then use a street mapping application (not shown) to convert the GPS location data to a street address. The system may use one or more factors such as time, current location, destination location, distance from the destination location, as well as others to determine that the driver may need directions to the destination location. Accordingly, the IVR system 204 may include directions to the destination in the system response. In some embodiments, the IVR system may be configured to provide an automated call to the destination location indicating that the mobile worker has arrived, is in transit, and/or provide an estimated arrival time. One or more of these features may be useful in the operation of taxis/shuttle services or any other mobile workforce.

The context of the communication device 202 may be dynamically updated. As indicated above, the communication device 202 may communicate (e.g., send data) automatically, without user input. Such automatic communication of data from the device 202 can dynamically update a context. For example, in some embodiments, IVR data application 210 automatically transmits location data, such as GPS data, substantially periodically. GPS data can be generated by the GPS application 212. GPS data may also be provided/generated by a telecommunications carrier associated with the communication channel 206. Intelligent IVR server 216 can use GPS location data to determine a location-based context associated with the communication device 202. This is particularly relevant to mobile field workers. Based on the GPS location of the worker, the intelligent IVR server 216 may be able to determine a particular job that the worker is on. In response, the IVR server 216 can provide a prompt 230 associated with the determined job, or provide associated tasks 228.

Accordingly, the intelligent IVR server 216 can use user ID information or other data that is automatically sent from the communication device 202 to automatically authenticate the user. When the user accesses the IVR system 204, there is no need for the user to go through the process of entering his/her user ID data. The IVR system 204 can immediately prompt the user to enter his/her intention.

In addition, the intelligent IVR server 216 may be able to determine an intention of the user without the user entering any input. Depending on the job, task or user location, in many cases the intention can be determined automatically using data in the database 220. For example, the GPS location provided by the communication device 202 may be associated with a particular job. The intelligent IVR server application 216 can identify the job by first indexing the GPS data 222, determining the associated job, and then indexing the job ID data 226. The determined job may be associated with one or more intentions, which can be retrieved from the set of intentions 234 data. The determined intention can be used to determine an IVR prompt, sequence of prompts or information for the user.

Other applications 214 executing on the communication device may include, but are not limited to, billing, time entry, job scheduling, and/or sales tracking applications. Information from these and other applications can be transmitted by the IVR data application 210 to the intelligent IVR server application 216. The intelligent IVR server application 216 can verify or identify IVR intentions associated with data gathered from any of the other applications 214.

The modules and data illustrated in FIG. 2 are for illustrative purposes only. As such, they are not intended to limit the scope of the invention. The communication device 202 may have more, fewer, or other modules than are shown in FIG. 2. Likewise, the server side IVR system 204 may have more, fewer, or other modules than those that are shown in FIG. 2, and the database 220 may have more, fewer, or other datasets than those that are shown. Importantly, the modules and datasets may be combined, broken out, or rearranged in any manner without departing from the scope of the invention.

Exemplary Operations

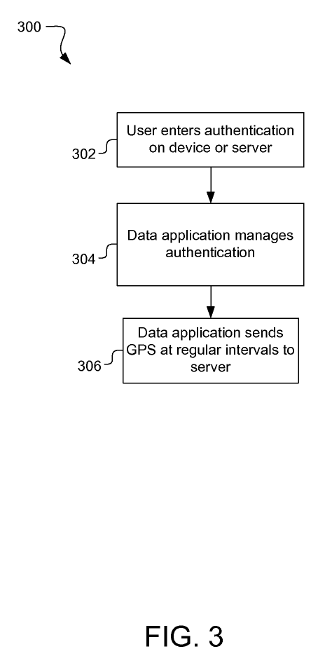

FIG. 3 is a flowchart illustrating an initialization algorithm 300 including exemplary operations in accordance with one embodiment. The initialization algorithm 300 generally provides the initial data that can be used by an intelligent IVR system to provide automatic IVR authentication and intention verification. The algorithm 300 may be carried out by a communication device such as those described above, or other communication devices that execute an application operable to output GPS data automatically and interact with an IVR system to automatically authenticate a user.

In an entering operation 302, the user enters his/her identification data such that the identification data is stored on an IVR server, device, or database, with which the user will later be interacting. The identification data may be any ID data appropriate for the situation and the particular embodiment. For example ID data may include, user name, password, code (e.g., a unique ID number), frequent flier number, bank account number, insurance policy/group number, or others.

After the user identification data is entered and stored, a managing operation 304 carries out the process of getting the user authenticated. The managing operation 304 may be carried out automatically by the user's communication device. The communication device first makes contact with the IVR system, for example, by dialing into the IVR system, or using PTT to make contact. Contacting the IVR system may be automatically performed by the communication device, or it may be manually carried out by the user. After connecting with the IVR system, the communication device handles user authentication, with no need for user input. The communication device will automatically authenticate the user by contacting the IVR system and providing the user's identification data.

In some embodiments the user is uniquely identified by a code. In such embodiments, the managing operation 304 may involve the communication device dialing into the IVR system, and some time (e.g., 1-10 seconds) after the IVR system connects, the transmitting the user code to the IVR system. The user code may be transmitted using dual-tone multi-frequency (DTMF) over a telecommunications channel, such as the Public Switched Telephone Network (PSTN). The user code may, but does not necessarily, correspond to the user's telephone extension in these embodiments.

After the user is authenticated, a sending operation 306 sends specified data to the IVR system. In the embodiment of FIG. 3, the sending operation 306 involves the IVR application of the communication device sending GPS data to the IVR system. The GPS data may or may not be sent repeatedly. For example, the GPS data may be sent at periodic intervals. In other embodiments, GPS data may be sent only when the user changes location more than a specified distance.

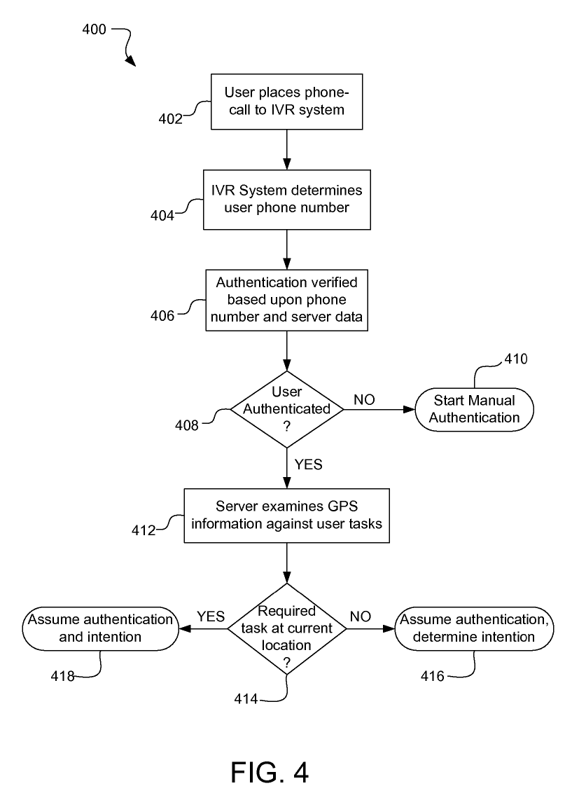

FIG. 4 is another flowchart illustrating a task context-sensitive IVR algorithm 400 including exemplary operations in accordance with a particular embodiment. Generally, the algorithm 400 attempts to automatically authenticate and automatically determine user intention based on user telephone number, GPS data, and determined user tasks. In some embodiments, the method involves determining whether certain user involvement may be eliminated and thereby streamline the IVR interaction. In the embodiment shown, the user is assumed to be a mobile field worker who performs jobs or tasks in the field.

Initially, the user contacts the IVR system in a calling operation 402. The IVR system may be contacted by dialing an associated telephone number using touchtone entry, or by using a push-to-talk (PTT) service. The IVR system then determines the user's telephone number in a determining operation 404. The telephone number can be determined by “caller ID” or in some other manner, including user entry of the telephone number. The IVR system then attempts to identify the user in an authenticating operation 406. In one embodiment of the authenticating operation 406, the IVR system uses the telephone number to look up user identification data in a database. If the user's telephone number exists in the database, this means the user previously initialized his/her IVR identification information.

At a query operation 408, it is determined whether the user is authenticated. If the system was unable to automatically authenticate the user based on the telephone number, the algorithm 400 branches “NO” to a manual authentication operation 410. The manual authentication operation 410 prompts the user to manually enter his/her identification data. After the user enters his/her ID data, the manual authentication operation 410 may save the ID data and the associated telephone number, so that future interactions will not require manual authentication.

If the query operation 408 determines that the use is authenticated, the algorithm 400 branches “YES” to an examining operation 412. Examining operation 412 retrieves GPS data associated with the user (e.g., current GPS location, or previously stored GPS location) and determines whether any tasks should be performed at the GPS location. In this way, the IVR system can automatically determine why the user has called in, or in other words, determine the user's intention. For example, if the user is a power company worker at a GPS location corresponding to a particular power company substation, certain tasks may be required, such as fixing a transformer, connecting power lines, etc.

Another query operation 414 then determines if any tasks are associated with the GPS location. If there are no tasks identified, the algorithm 400 branches “NO” to an assuming operation 416 in which it is assumed that the user has been authenticated, but the user's intention has not been determined. In assuming operation 416, the user may be prompted to manually enter his/her intention. A menu of options may be presented audibly to the user. For example, the user may by prompted to “press 1 if . . . ”, “press 2 if . . . ”, etc.

However, if the query operation 414 determines that a task is associated with the current location, the algorithm 400 branches “YES” to another assuming operation 418. In assuming operation 418, it is assumed that the user identity is known and the user's intention is known. As a result, the user does not need to enter any information to indicate his/her purpose for the call. The IVR system can then automatically provide IVR services to the user based on the automatically determined user's identity and task.

The operations shown in FIGS. 3 and 4 are not limited to the particular order shown. Operations may be performed in different orders, in parallel, or otherwise. In addition, steps included in each operation may be broken out and/or moved into other operations.

Exemplary Computing Device

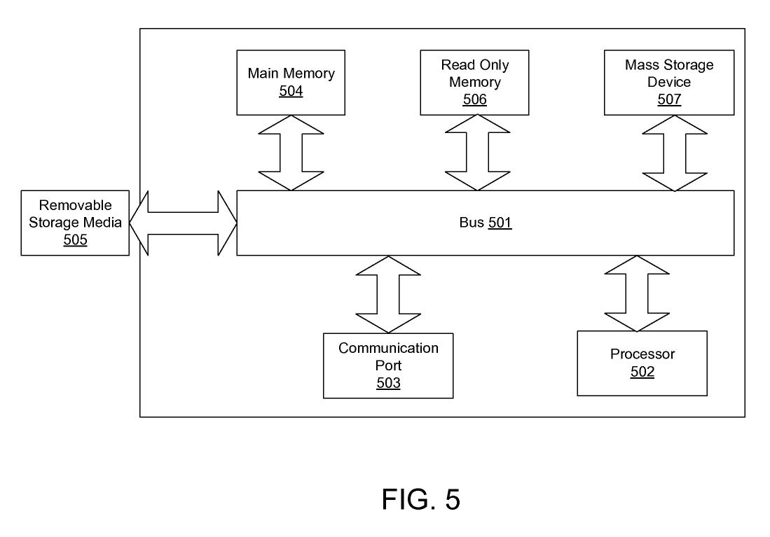

FIG. 5 is a schematic diagram of a computing device 500 upon which an IVR authentication and intention verification system may be implemented and/or a mobile communication device may be implemented. As discussed herein, embodiments of the present invention include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

According to the present example, the computing device 500 includes a bus 501, at least one processor 502, at least one communication port 503, a main memory 504, a removable storage media 505 a read only memory 506, and a mass storage 507. Processor(s) 502 can be any know processor, such as, but not limited to, an Intel® Itanium® or Itanium ® processor(s), or AMD® Opteron® or Athlon MP® processor(s), or Motorola ® lines of processors. Communication port(s) 503 can be any of an RS-232 port for use with a modem based dialup connection, a 10/100 Ethernet port, or a Gigabit port using copper or fiber. Communication port(s) 503 may be chosen depending on a network such a Local Area Network (LAN), Wide Area Network (WAN), or any network to which the computing device 500 connects. The computing device 500 may be in communication with peripheral devices (not shown) such as, but not limited to, printers, speakers, cameras, microphones, or scanners.

Main memory 504 can be Random Access Memory (RAM), or any other dynamic storage device(s) commonly known in the art. Read only memory 506 can be any static storage device(s) such as Programmable Read Only Memory (PROM) chips for storing static information such as instructions for processor 502. Mass storage 507 can be used to store information and instructions. For example, hard disks such as the Adaptec® family of SCSI drives, an optical disc, an array of disks such as RAID, such as the Adaptec family of RAID drives, or any other mass storage devices may be used.

Bus 501 communicatively couples processor(s) 502 with the other memory, storage and communication blocks. Bus 501 can be a PCI/PCI-X or SCSI based system bus depending on the storage devices used. Removable storage media 405 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is

1. A server side interactive voice response (IVR) system comprising:
an interface module configured to receive one or more user attributes from a communication device via a communications channel prior to an IVR interaction with a user; and
an intelligent interactive voice response (IVR) server configured to automatically authenticate the user based on the one or more user attributes, without requiring the user to enter user identification data.

2. An IVR system as recited in claim 1, wherein the IVR server is further configured to determine an intention of the user based on the one or more user attributes and determine an IVR system response based on the determined intention of the user, and further configured to transmit the IVR system response to the communication device.

3. The IVR system of claim 1, further comprising a memory storing user context determination data.

4. The IVR system of claim 3, wherein the user context determination data comprises job identification data, user identification data, location data, or global positioning system data.

5. The IVR system of claim 1, wherein the one or more user attributes includes one or more of a user identification, time, a job identification, task data, and location data.

6. The IVR system of claim 5, wherein user identification data includes a user name, a password, a code, a frequent flier number, a bank account number, or an insurance policy/group number.

7. The IVR system of claim 1, wherein the one or more user attributes include location data from one a mobile communication device associated with a mobile user and wherein the location data is then used by the intelligent IVR server to determine a current activity of the mobile user.

8. The IVR system of claim 1, further including a set of standard response options, wherein part of the set of standard response options are eliminated based on the determined intention of the user before the IVR system response is transmitted to the communication device.

9. The IVR system of claim 1, further comprising an application module to host one or more applications which may be accessed by the communication device.

10. A method comprising:
receiving a first communication signal from a communication device, wherein the first communication signal includes one or more user attributes associated with a user of the communication device;
authenticating the user of the communication device by matching one or more of the user attributes received in the communication signal with context determination data;
determining a user intent based on the one or more user attributes;
transmitting a second communication signal to the communication device, wherein the second communication signal includes a menu of one or more options based on the determined user intent.

11. The method of claim 10, determining the user intent further comprises determining a user context based on the one or more user attributes.

12. The method of claim 10, wherein if determining the user intent fails, the menu of one or more options included in the second communication signal is a standard option menu.

13. The method of claim 10, wherein the menu of one or more options includes an IVR prompt, sequence of prompts or information for the user.

14. The method of claim 10, wherein the one or more user attributes include an identification indicator to identify the user of the communication device.

15. The method of claim 10, wherein the communication device is able to determine a current position based on global positioning system (GPS) data and wherein determining the user intent comprises:
determining the current position based on GPS data;
determining one or more activities associated with the current position; and
using a job identification indicator included in the one or more user attributes to index into the one or more activities.

16. A computer readable medium having computer-executable instructions, which when executed, cause the computer to perform the method of claim 10.

17. A communication device comprising:
a memory store having stored thereon one or more executable applications to interact with an intelligent interactive voice recognition (IVR) system;
an input/output (I/O) module to provide one or more modes of communication service between the communication device and an IVR server;
a data application module configured to send and receive data to and from an IVR server application via the I/O module; and
a user attribute module configured to receive and record one or more user attributes associated with a user of the communication device.

18. The communication device of claim 16, wherein the one or more modes of communication include push-to-talk or full-duplex communication.

19. The communication device of claim 16, wherein the user attribute module automatically transmits one or more quality indicators to the IVR server on a prescheduled, periodic, or event driven schedule.

20. The communication device of claim 16, further comprising a global positioning system to determine a current location of the communication device and provide the current location to the data application module.

21. The communication device of claim 16, further comprising a user interface allowing the user to set one or more user attributes.
